(19) United States
(12) Patent Application Publication
(10) Pub. No.: US 2023/0040240 A1
(43) Pub. Date: Feb. 9, 2023

(54) ELECTRONIC DEVICE

(71) Applicant: InnoLux Corporation, Miao-Li County (TW)

(72) Inventors: Yu-Cheng HSIAO, Miao-Li County (TW); Hong-Sheng HSIEH, Miao-Li County (TW)

(21) Appl. No.: 17/811,902

(22) Filed: Jul. 12, 2022

(30) Foreign Application Priority Data
Aug. 9, 2021 (CN) 202110907906.1

(51) Int. Cl. G02B 1/115; H05F 3/00

(52) U.S. Cl. CPC G02B 1/115; H05F 3/00

(57) ABSTRACT

An electronic device is provided. The electronic device includes a display panel, a conductive layer, and a first refractive index matching layer. The first refractive index matching layer is between the conductive layer and the second substrate. The refractive index of the first refractive index matching layer is smaller than the refractive index of the conductive layer. The display panel includes a first substrate and a second substrate. The second substrate is above the first substrate.

### CROSS REFERENCE TO RELATED APPLICATIONS

This application claims priority of China Patent Application No. 202110907906.1, filed on Aug. 9, 2021, the entirety of which is incorporated by reference herein.

### BACKGROUND OF THE INVENTION

### Field of the Invention

The present disclosure relates to an electronic device, and, in particular, to an electronic device including a refractive index matching layer.

### Description of the Related Art

Currently, a display panel will include an antistatic layer above a panel to reduce the level of static residue. However, the difference in the refractive index between the antistatic layer and the substrate of the panel will increase the reflectivity of the display panel. Therefore, the contrast of the display panel would be lower, thereby impacting the performance of the display panel.

### BRIEF SUMMARY OF THE INVENTION

In view of the above problems, the present disclosure provides an electronic device including a refractive index matching layer.

The present disclosure relates to an electronic device. The electronic device includes a display panel, a conductive layer and a first refractive index matching layer. The display panel includes a first substrate and a second substrate above the first substrate. The second substrate is above the first substrate. The conductive layer is above the second substrate. The second substrate is between the first substrate and the conductive layer. The first refractive index matching layer is between the conductive layer and the second substrate. The refractive index of the first refractive index matching layer is smaller than the refractive index of the conductive layer.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 shows a top schematic view of an electronic device according to some embodiments of the present disclosure.

FIG. 2 shows a cross-sectional schematic view of an electronic device of FIG. 1 according to some embodiments of the present disclosure, taken along line X′-X″ of FIG. 1.

FIG. 3 shows a cross-sectional schematic view of an electronic device of FIG. 1 according to some embodiments of the present disclosure, taken along line X′-X″ of FIG. 1.

FIG. 4 shows a top schematic view of an electronic device according to some embodiments of the present disclosure.

FIG. 5 shows a cross-sectional schematic view of an electronic device of FIG. 4 according to some embodiments of the present disclosure, taken along line X′-X″ of FIG. 4.

FIG. 6 shows the relationship between the reflectivity and the thickness of a refractive index matching layer of an electronic device of the embodiment shown in FIG. 5.

FIG. 7 shows a cross-sectional schematic view of an electronic device of FIG. 4 according to some embodiments of the present disclosure, taken along line X′-X″ of FIG. 4.

FIG. 8 shows the relationship between the reflectivity and the thickness of a refractive index matching layer of an electronic device of the embodiment shown in FIG. 7.

FIG. 9 shows a cross-sectional schematic view of an electronic device of FIG. 4 according to some embodiments of the present disclosure, taken along line X′-X″ of FIG. 4.

FIG. 10 shows the relationship between the reflectivity and the thickness of a refractive index matching layer of an electronic device of the embodiment shown in FIG. 9.

FIG. 11 shows the relationship between the reflectivity and the thickness of a refractive index matching layer of an electronic device of the embodiment shown in FIG. 9.

### DETAILED DESCRIPTION OF THE INVENTION

The following is a detailed description of an electronic device of an embodiment of the present disclosure. It should be understood that, in the following description, various embodiments and examples are provided in order to implement the different aspects of some embodiments of the present disclosure. The specific elements and arrangements described in the following description are set forth in order to describe some embodiments of the present disclosure in a clear and easy manner. Of course, these are only used as examples but not as limitations of the present disclosure. In addition, like and/or corresponding numerals may be used in different embodiments to denote like and/or corresponding elements in order to clearly describe the present disclosure. However, the use of like and/or corresponding numerals are merely for the purpose of simplicity and clarity of the description of some embodiments of the present disclosure, and are not intended to suggest any correlation between different embodiments and/or structures discussed.

It should be understood that, spatially relative terms, such as “below,” “bottom,” “above,” “top” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. If the devices depicted in the figures are turned upside down, the element described as being on the “below” side will become the element on the “above” side. Embodiments of the present disclosure could be understood in conjunction with the accompanying figures. The accompanying drawings of present disclosure should be considered to be a part of the description of the present disclosure. It should be understood that the features the accompanying figures are not drawn to scale. In fact, the dimensions of the features may be arbitrarily increased or reduced for clarity of discussion.

Further, the description of a first material layer above or on a second material layer in the description that follows may include embodiments in which the first material layer and second material layer are formed in direct contact, and may also include embodiments the first material layer and second material layer are not in direct contact, that is, one or more material layers may be formed between the first material layer and second material layer. However, the description of the first material layer is directly on the second material layer means that the first material layer is in direct contact with the second material layer.

Moreover, it should be understood that the use of ordinal terms such as “first”, “second”, etc., in the disclosure to modify an element does not by itself connote any priority, precedence, or order of one claim element over another or the temporal order in which it is formed, but are used merely as labels to distinguish one claim element having a certain name from another element having the same name (but for use of the ordinal term) to distinguish the claim elements. The terminology used in the claims and the specification may not be the same, for example, the first element in the specification may be the second element in the claims.

In some embodiments of the present disclosure, unless otherwise defined herein, terms of engagement, connection, etc., such as “join”, “connection”, etc., may mean that the two structures are in direct contact, or that the two structures are not in direct contact and other structures are located between the two structures. The terms join and connection may also include cases in which both of the two structures are movable, or in which both of the two structures are fixed. In addition, the terms “electrically connect” or “couple” include any direct and indirect means of electrical connection.

It will be understood that, the term “about”, “approximate”, as used herein usually indicates a value of a given value or range that varies within 10%, preferably within 5%, or within 3%, or within 2%, or within 1%, or within 0.5%. The value given here are approximate value, i.e., “about”, or “approximate”, may be implied without specifying “about”, or “approximate”. It will be further understood that the expression “between a first value and a second value” used herein to indicate a specific range including the said first value, the said second value, and values between thereof.

It is to be understood that in the embodiments exemplified below, features from several different embodiments may be replaced, rearranged, and combined to complete other embodiments without departing from the spirit of the present disclosure. The features of each embodiment can be combined and used in any way as long as they do not contradict the spirit of the present disclosure or conflict with each other.

Unless otherwise defined, all terms (including technical and scientific terms) used herein have the same meaning as commonly understood by a person skilled in the art to which the invention pertains. It will be further understood that terms, such as those defined in commonly used dictionaries, should be interpreted as having a meaning consistent with the relevant technology and the context or background of this disclosure and will not be interpreted in an idealized or overly formal sense unless expressly so defined herein.

The electronic device of the present disclosure may include a display device, an antenna device, or a sensing device, but not limited there to. The display device may include a touch display device, a curved display device, a free shape display device or a flexible display device, but the present disclosure is not limited there to. The antenna device may be, for example, a liquid crystal antenna, but not limited there to. The aforementioned devices may be formed by splicing, and include, for example, a display splicing device or an antenna splicing device, but is not limited thereto. It should be noted that the electronic device can be but not limited to any combination of the aforementioned devices. In addition, a shape of the electronic device may be a rectangle, a circle, a polygon, a shape with curved edges, or other suitable shape. The electronic device may have peripheral systems, such as a drive system, control system, light source system, shelf system and the likes for supporting the electronic device. The electronic device of the present disclosure may be an electronic device having any function of a display panel. Hereinafter, a display device will be used as an example to illustrate the contents of the present disclosure, but types of the electronic device of the present disclosure are not limited thereto.

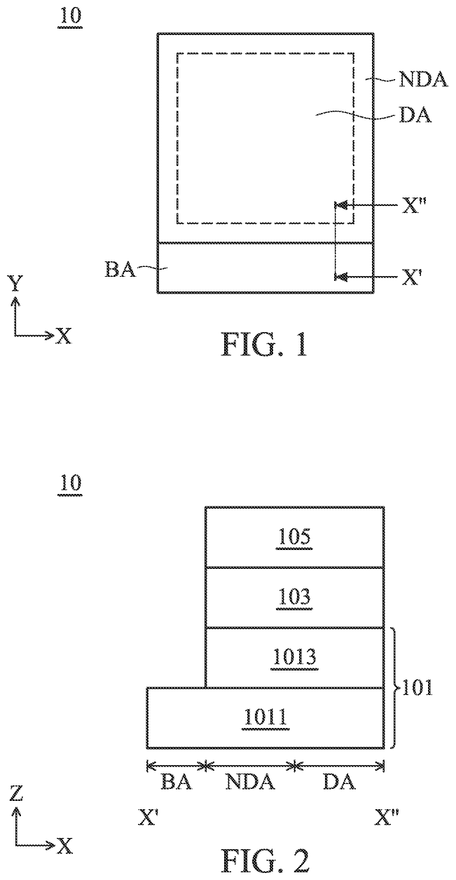

Please refer to FIGS. 1 and 2. FIG. 1 shows a top schematic view of an electronic device 10 according to some embodiments of the present disclosure when viewed in a use direction. FIG. 2 shows a cross-sectional schematic view of the electronic device 10 of FIG. 1 according to some embodiments of the present disclosure, taken along line X′-X″ of FIG. 1. Referring to FIG. 1 and FIG. 2, the electronic device 10 of some embodiments of the present disclosure includes a display panel 101, a conductive layer 105, and a first refractive index matching layer 103 between the display panel 101 and the conductive layer 105.

The display panel 101 may be divided into a display area DA, a non-display area NDA surrounding the display area DA, and a bonding area BA electrically connected to an external chip (not shown). A plurality of display units (not shown) are located in the display area DA to display images in the display area DA. In particular, in the present disclosure, the display panel includes a plurality of scan lines controlling the switching of the display units and a plurality of data lines providing image data. The scan lines and the data lines are extended in different directions. Two adjacent data lines among the data lines and two adjacent scan lines among the scan lines may define a display unit. The display unit can be used to display images according to the switching state of the display unit and the received image data. The display panel 101 may include a display medium (not shown), the display medium may include liquid crystals, light emitting diodes (LEDs), quantum dots (QDs), fluorophores (fluorescence), phosphors or other suitable materials. The light-emitting diodes may include mini light-emitting diodes (mini-LEDs), micro light-emitting diodes (micro-LEDs), quantum dot light-emitting diodes (quantum dot LEDs, QLEDs/QDLEDs) or organic light-emitting diodes (OLEDs), but not limited thereto.

According to some embodiments of the present disclosure, the display panel 101 includes a first substrate 1011 and a second substrate 1013. In the embodiment, each display unit located in the display area DA may include a related portion of the first substrate 1011 and a related portion of the second substrate 1013. In some embodiments, a thin-film transistor (TFT, not shown) may be provided above the first substrate 1011, but is not limited thereto. In some embodiments, a color filter layer (not shown) may be provided above the surface of the second substrate 1013. In this embodiment, the second substrate 1013 may be provided above the first substrate 1011, and the color filter layer is between the second substrate 1013 and the first substrate 1011. The second substrate 1013 may include a material having a refractive index between 1.48 and 1.52 (1.48≤refractive index≤1.52). Examples of the material may include glass, quartz, sapphire, ceramic, polyimide (PI), polycarbonate (PC), polyethylene terephthalate (PET), polypropylene (PP), other suitable materials, or a combination of the thereof. In some embodiments, a display medium layer may be further provided between the first substrate 1011 and the second substrate 1013. In this embodiment, each display unit located in the display area DA may include a related portion of the first substrate 1011, a related portion of the display medium layer, and a related portion of the second substrate 1013. It should be noted that, in order to electrically connect the display panel 101 to an external chip, the bonding area BA typically includes an area of one of the substrates (e.g., the first substrate 1011) that is exposed by removing a portion of the other substrate (e.g., the second substrate 1013). Bonding pads are formed in that exposed area, so that signals from the external chip can be transmitted to the display area DA via the bonding pad and wires (not shown).

The conductive layer 105 may be above the display panel 101. The second substrate 1013 is between the conductive layer 105 and the first substrate 1011. The conductive layer 105 may cover at least the entire display area DA of the display panel 101. In particular, referring to the top view of the electronic device 10 shown in FIG. 1, when a user looks down the electronic device 10 in a use direction, the display area DA of the display panel 101 is covered by the conductive layer 105 entirety without being exposed to the outside. In other words, a projection of the conductive layer 105 onto the display panel 101 will at least overlap the entire display area DA of the display panel 101. In some embodiments, the conductive layer 105 may cover the entire display area DA and a portion or entire of the non-display area NDA of the display panel 101. That is, a projection of the conductive layer 105 onto the display panel 101 will overlap the entire display area DA and a portion or entire of the non-display area NDA of the display panel 101. As shown in FIG. 1, the conductive layer 105 may cover the entire display panel 101 including the display area DA and the non-display area NDA. It is important to note that the conductive layer 105 can be used as an antistatic layer to reduce the light leakage from the display area DA resulted from an additional electric field in the display panel 101 caused by charge residue.

The conductive layer 105 may include a transparent conductive material having a refractive index between 1.7 and 2.1 (1.7≤refractive index≤2.1). Examples of the transparent conductive material may include transparent conductive metal oxides and thin metal films, but the present disclosure is not limited thereto. Examples of the transparent conductive metal oxides may include, but are not limited to, indium tin oxide (ITO), indium-doped zinc oxide (IZO), indium gallium zinc oxide (InGaZnO), aluminum zinc oxide (Al-doped ZnO, AZO), and the like. The thickness of the conductive layer 105 may be between 50 Å and 230 Å(50 Å≤thickness 230 Å). In some embodiments, the thickness of the conductive layer 105 may be between 80 and 200 Å (80 Å≤thickness≤200 Å), between 100 and 180 Å (100 Å≤thickness≤180 Å), or between 100 and 150 Å(100 Å≤thickness≤150 Å). When the conductive layer 105 is directly combined with the second substrate 1013, because of the difference between the refractive index of the material in the conductive layer 105 and that in the second substrate 1013, the reflectivity of the interface between the conductive layer 105 and the second substrate 1013 will increase. When the reflectivity is too high, the display panel will reflect more external light whenever the display panel is illuminated by an external light source, thereby lowering the contrast of the display panel and impacting the proper functioning of the display panel.

The first refractive index matching layer 103 is between the conductive layer 105 and the display panel 101. In particular, the first refractive index matching layer 103 may be between the conductive layer 105 and the second substrate 1013, and it may be in direct contact with the second substrate 1013 and the conductive layer 105. The first refractive index matching layer 103 may at least cover the entire display area DA of the display panel 101. In particular, referring to the top view of the electronic device 10 shown in FIG. 1, the entire display area DA of the display panel 101 can be covered by the first refractive index matching layer 103 without being exposed to outside when a user looking down from a normal direction of the display panel 101. In other words, a projection of the first refractive index matching layer 103 onto the display panel 101 will completely overlap the display area DA of the display panel 101. By covering the entire display area DA of the display panel 101, the first refractive index matching layer 103 can reduce the reflectivity of the entire display area DA, thus enhancing the display quality observed by the user. In some embodiments, the first refractive index matching layer 103 may cover the entire display area DA and a portion or entire of the non-display area NDA of the display panel 101. That is, a projection of the first refractive index matching layer 103 onto the display panel 101 will overlap the entire display area DA and a portion or entire of the non-display area NDA of the display panel 101. It is important to note that the reflectivity of the interface between the substrate or a film layer (e.g., conductive layer 105, first refractive index matching layer 103, or second substrate 1013) and an adjacent film layer can be adjusted by selecting the material and/or thickness of the substrate or the film layer and the adjacent film layer.

In some embodiments, the refractive index of the first refractive index matching layer 103 may be smaller than the refractive index of the conductive layer 105. For example, in the embodiments where the conductive layer 105 includes a material with a refractive index between 1.7 and 2.1 (1.7≤refractive index≤2.1), the first refractive index matching layer 103 may include a material with a refractive index between 1.38 and 1.9 (1.38≤refractive index≤1.9). In the above embodiments, the refractive index of the first refractive index matching layer 103 may be smaller than that of the conductive layer 105 by adjusting the materials of each layer included in the first refractive index matching layer 103. In some embodiments, the materials in the first refractive index matching layer 103 may include silicon oxide (SiOx), silicon nitride (SiNx), silicon oxynitride (SiOxNy), magnesium fluoride (MgF₂), or a combination thereof, but the present disclosure is not limited thereto. The thickness of the first refractive index matching layer 103 can be adjusted according to the material included in the first refractive index matching layer 103, as long as the refractive index of the final first refractive index matching layer 103 is between the refractive index of the conductive layer 105 and the refractive index of the second substrate 1013. For example, when the material included in the first refractive index matching layer is magnesium fluoride, the thickness of the first refractive index matching layer may be between 50 Å and 1000 Å (50 Å≤thickness≤1000 Å), and the thickness of the conductive layer 105 may be between 50 and 230 Å (50 Å≤thickness≤230 Å). The above thickness of each layer indicates a maximum thickness of the each layer in a profile, which is measured in a normal direction Z of the first substrate 1011.

In some embodiments, the refractive index of the first refractive index matching layer 103 is between the refractive index of the conductive layer 105 and the refractive index of the second substrate 1013. For example, in the embodiments where the conductive layer 105 includes a material with a refractive index between 1.7 and 2.1 (1.7≤refractive index≤2.1) and the second substrate 1013 includes a material with a refractive index between 1.48 and 1.52 (1.48≤refractive index≤1.52), the first refractive index matching layer 103 may include a material with a refractive index between 1.48 and 1.9 (1.48≤refractive index≤1.9). In the above embodiments, the refractive index of the first refractive index matching layer 103 may be between the refractive index of the conductive layer 105 and the refractive index of the second substrate 1013 by adjusting the materials of each layer included in the first refractive index matching layer 103. In some embodiments, the materials in the first refractive index matching layer 103 may include silicon oxide (SiOx), silicon nitride (SiNx), silicon oxynitride (SiOxNy), magnesium fluoride (MgF₂), or a combination thereof, but the present disclosure is not limited thereto. The first refractive index matching layer 103 may include any material with a refractive index between the refractive index of the conductive layer and the refractive index of the second substrate.

The thickness of the first refractive index matching layer 103 may be between 50 and 2000 Å (50 Å≤thickness≤2000 Å). In some embodiments, the thickness of the first refractive index matching layer 103 is between 500 and 1800 Å (500 Å≤thickness≤1800 Å), between 1000 and 1600 Å (1000 Å≤thickness≤1600 Å), or between 1300 and 1500 Å (1300 Å≤thickness≤1500 Å). The thickness of the first refractive index matching layer 103 can be adjusted according to the material included in the first refractive index matching layer 103, as long as the refractive index of the final first refractive index matching layer 103 is between the refractive index of the conductive layer 105 and the refractive index of the second substrate 1013. The problem of lowering contrast of the display panel when the display panel is illuminated by an external light source resulted from the high reflectivity of the display panel can be further resolved by adjusting the material and/or thickness of the first refractive index matching layer 103.

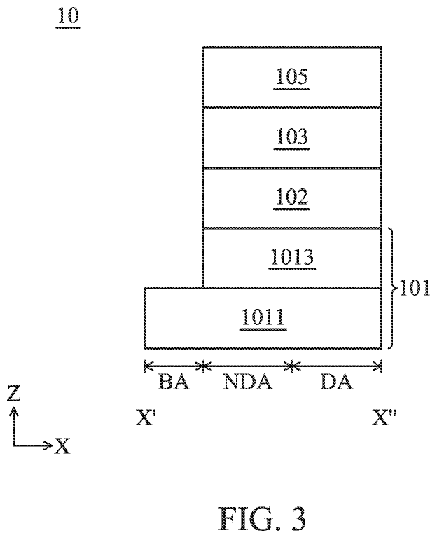

FIG. 3 shows a cross-sectional schematic view of the electronic device 10 of FIG. 1 according to other embodiments of the present disclosure, taken along line X′-X″ of FIG. 1. Referring to FIG. 1 and FIG. 3, the electronic device 10 of some embodiments of the present disclosure includes a display panel 101, a conductive layer 105, a first refractive index matching layer 103 between the display panel 101 and the conductive layer 105, and a second refractive index matching layer 102 between the display panel 101 and the first refractive index matching layer 103.

As mentioned above, the display panel 101 may be divided into a display area DA, a non-display area NDA surrounding the display area DA, and a bonding area BA electrically connected to an external chip (not shown). A plurality of display units (not shown) are located in the display area DA to display images in the display area DA. Each display unit located in the display area DA may include a related portion of the first substrate 1011 and a related portion of the second substrate 1013.

The conductive layer 105 above the display panel 101 is used as an antistatic layer. The second substrate 1013 is between the conductive layer 105 and the first substrate 1011. The conductive layer 105 may cover at least the entire display area DA of the display panel 101. In some embodiments, the conductive layer 105 may cover the entire display area DA and a portion or entire non-display area NDA of the display panel 101.

Since the conductive layer 105 in this embodiment may have the same or similar material and thickness as that of the conductive layer 105 in the previous embodiment, the material and thickness of the conductive layer 105 in this embodiment will not be repeated here.

The first refractive index matching layer 103 is between the conductive layer 105 and the second substrate 1013. In some embodiments, the first refractive index matching layer 103 may be in direct contact with the conductive layer 105. The first refractive index matching layer 103 may cover at least the entire display panel 101 of the display area DA. In some embodiments, the first refractive index matching layer 103 may cover the entire display area DA and a portion or entire of the non-display area NDA of the display panel 101.

Since the first refractive index matching layer 103 in this embodiment may have the same or similar material and thickness as that of the first refractive index matching layer 103 in the previous embodiment, the material and thickness of the first refractive index matching layer 103 in this embodiment will not be repeated here.

The thickness of the first refractive index matching layer 103 may be between 50 and 2000 Å(50 Å≤thickness≤2000 Å). For example, the thickness of the first refractive index matching layer 103 may be between 50 Å and 1000 Å(50 Å≤thickness≤1000 Å), between about 50 Å and 1800 Å(50 Å≤thickness≤1800 Å), between about 100 Å and 1500 Å(100 Å≤thickness 1500 Å), or between about 100 Å and 1100 Å(100 Å≤thickness≤1100 Å). The problem of lowering contrast of the display panel when the display panel is illuminated by an external light source resulted from the high reflectivity of the display panel can be further resolved by adjusting the material and/or thickness of the first refractive index matching layer 103.

The second refractive index matching layer 102 is between the first refractive index matching layer 103 and the display panel 101. In particular, the second refractive index matching layer 102 is between the first refractive index matching layer 103 and the second substrate 1013 and may be in direct contact with the first refractive index matching layer 103 and the second substrate 1013.

In some embodiments, the second refractive index matching layer 102 may cover at least the entire display panel 101 of the display area DA. In particular, referring to the top view of the electronic device 10 shown in FIG. 1, when a user looks down the electronic device 10 in a use direction, the display area DA of the display panel 101 may be covered by the second refractive index matching layer 102 entireties without being exposed to the outside. By covering the entire display area DA of display panel 101, the second refractive index matching layer 102 can lower the reflectivity of the entire display area DA or enhance the display quality observed by the user. In other words, a projection of the second refractive index matching layer 102 onto the display panel 101 will at least overlap the entire display area DA of the display panel 101. In some embodiments, a projection of the second refractive index matching layer 102 onto the display panel 101 will overlap the entire display area DA of the display panel 101 and overlap a portion or entire of the non-display area NDA of the display panel 101. In some embodiments, the coverage area of the second refractive index matching layer 102 may be the same as that of the first refractive index matching layer 103, but the present disclosure is not limited thereto.

The refractive index of the second refractive index matching layer 102 may be larger than or equal to the refractive index of the first refractive index matching layer 103. For example, in the embodiments where the conductive layer 105 includes a material with a refractive index between 1.7 and 2.1 (1.7≤refractive index≤2.1), the second substrate 1013 includes a material with a refractive index between 1.48 and 1.52 (1.48≤refractive index≤1.52), and the first refractive index matching layer 103 includes a material with a refractive index between 1.38 and 1.9 (1.38≤refractive index≤1.9), the second refractive index matching layer 102 may include a material with a refractive index between 1.48 and 2.1 (1.48≤refractive index≤2.1). The materials in the second refractive index matching layer 102 may be selected according to the materials in the conductive layer 105, the second substrate 1013, and the first refractive index matching layer 103. The second refractive index matching layer 102 may include any materials having a refractive index between the refractive index of the conductive layer 105 and the refractive index of the second substrate 1013 and larger than or equal to the refractive index of the first refractive index matching layer 103. For example, in the embodiments where the first refractive index matching layer 103 includes silicon oxide (SiOx), silicon nitride (SiNx), silicon oxynitride (SiOxNy), magnesium fluoride (MgF₂), or a combination thereof. The second refractive index matching layer 102 may include materials selected from the following list: silicon oxide (SiOx), silicon nitride (SiNx), silicon oxynitride (SiOxNy), titanium oxide (TiOx), niobium oxide (NbₓO_{y}), and indium tin oxide (ITO). This is done to ensure that the refractive index of the second refractive index matching layer 102 is between the refractive index of the conductive layer 105 and the refractive index of the second substrate 1013, and that it is larger than or equal to the refractive index of the first refractive index matching layer 103. The materials of the first refractive index matching layer 103 and the second refractive index matching layer 102 in the present disclosure are not limited to the materials mentioned above.

The thickness of the second refractive index matching layer 102 may be between about 50 Å and 2000 Å(50 Å≤thickness≤2000 Å). In some embodiment, the thickness of the second refractive index matching layer 102 is between about 50 Å and 1800 Å(50 Å≤thickness 1800 Å), between about 100 Å and 1600 Å(100 Å≤thickness≤1600 Å), or between about 100 Å and 1500 Å(100 Å≤thickness≤1500 Å). The thickness of the second refractive index matching layer 102 can be adjusted as needed. The problem of lowering contrast of the display panel when the display panel is illuminated by an external light source resulted from the high reflectivity of the display panel can be further resolved by including the above material and/or thickness in the second refractive index matching layer 102.

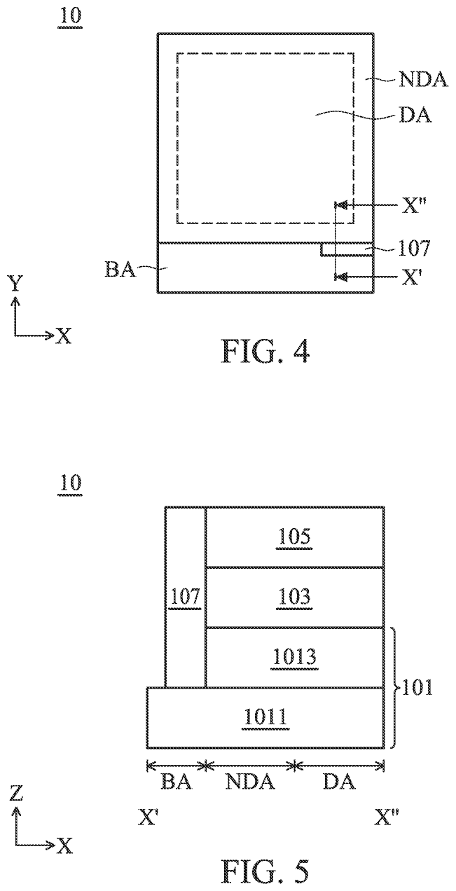

FIG. 4 shows a top schematic view of an electronic device 10 according to some other embodiments of the present disclosure in a use direction. FIG. 5 shows a cross-sectional schematic view of the electronic device 10 of FIG. 4 according to some embodiments of the present disclosure, taken along line X′-X″ of FIG. 4. Referring to FIG. 4 and FIG. 5, the electronic device 10 of some other embodiments of the present disclosure includes a display panel 101, a conductive layer 105, a first refractive index matching layer 103 between the display panel 101 and the conductive layer 105, and a conductive pattern 107 electrically connect the display panel 101 and the conductive layer 105. The conductive pattern 107 can be formed from silver glue or other suitable conductive materials.

Please refer to FIG. 4. Similar to the previous embodiments, the display panel 101 may be divided into a display area DA, a non-display area NDA surrounding the display area DA, and a bonding area BA electrically connected to an external chip (not shown). A plurality of display units are located in the display area DA to display images in the display area DA. Each display unit located in the display area DA may include a related portion of the first substrate 1011 and a related portion of the second substrate 1013. The conductive pattern 107 may be located in the bonding area BA and may electrically connect the display panel 101 and the conductive layer 105.

The conductive layer 105 is above the display panel 101, and the second substrate 1013 is between the conductive layer 105 and the first substrate 1011. Since the location, the coverage area, the materials, and the thickness of the conductive layer 105 in this embodiment may be the same as or similar with that of the conductive layer 105 in the previous embodiment, the location, the coverage area, the materials, and the thickness of the conductive layer 105 in this embodiment will not be repeated here.

In some embodiments, the refractive index of the first refractive index matching layer 103 is smaller than the refractive index of the conductive layer 105. For example, in the embodiments where the conductive layer 105 includes a material with a refractive index between 1.7 and 2.1 (1.7≤refractive index≤2.1), the first refractive index matching layer 103 may include a material with a refractive index between 1.38 and 1.9 (1.38≤refractive index≤1.9). In some embodiments, the refractive index of the first refractive index matching layer 103 is between the refractive index of the conductive layer 105 and the refractive index of the second substrate 1013. For example, in the embodiments where the conductive layer 105 includes a material with a refractive index between 1.7 and 2.1 (1.7≤refractive index≤2.1) and the second substrate 1013 includes a material with a refractive index between 1.48 and 1.52 (1.48≤refractive index≤1.52), the first refractive index matching layer 103 may include a material with a refractive index between 1.48 and 1.9 (1.48≤refractive index≤1.9), such as silicon oxide (SiOx), silicon nitride (SiNx), silicon oxynitride (SiOxNy), and magnesium fluoride (MgF₂), or a combination thereof, but the present disclosure is not limited thereto. The first refractive index matching layer 103 may include any material with a refractive index between the refractive index of the conductive layer 105 and the refractive index of the second substrate 1013.

The thickness of the first refractive index matching layer 103 may be between 50 Å and 2000 Å(50 Å≤thickness≤2000 Å). For example, in some embodiments, the thickness of the first refractive index matching layer 103 may be between 500 Å and 1800 Å(500 Å≤thickness 1800 Å), between about 1000 Å and 1600 Å(1000 Å≤thickness≤1600 Å), or between about 1300 Å and 1500 Å(1300 Å≤thickness≤1500 Å). The thickness of the first refractive index matching layer 103 may be adjusted according to the material included in the first refractive index matching layer 103, as long as the refractive index of the final first refractive index matching layer 103 is between the refractive index of the conductive layer 105 and the refractive index of the second substrate 1013. For example, in the embodiments where the material included in the first refractive index matching layer 103 have a refractive index between 1.48 and 1.9 (1.48≤refractive index≤1.9), the thickness of the first refractive index matching layer 103 may be between 50 Å and 2000 Å(50 Å≤thickness≤2000 Å). The problem of lowering contrast of the display panel when the display panel is illuminated by an external light source resulted from the high reflectivity of the display panel can be further resolved by adjusting the material and/or thickness of the first refractive index matching layer.

In some embodiments, the electronic device 10 may further include a second refractive index matching layer (not shown) between the first refractive index matching layer 103 and the display panel 101. The second refractive index matching layer may have a structure the same as or similar with that of the second refractive index matching layer 102 of the electronic device 10 in the previous embodiment, and the coverage area of the second refractive index matching layer 102 may be the same as the coverage area of the first refractive index matching layer 103. The second refractive index matching layer 102 may include any material with a refractive index between the refractive index of the conductive layer 105 and the refractive index of the second substrate 1013 and larger than or equal to the refractive index of the first refractive index matching layer 103. In the embodiments where the conductive layer 105 includes a material with a refractive index between 1.7 and 2.1 (1.7≤refractive index≤2.1), the second substrate 1013 includes a material with a refractive index between 1.48 and 1.52 (1.48≤refractive index≤1.52), and the first refractive index matching layer 103 includes a material with a refractive index between 1.38 and 1.9 (1.38≤refractive index≤1.9), the second refractive index matching layer 102 may include a material with a refractive index between 1.48 and 2.1 (1.48≤refractive index≤2.1). The materials in the second refractive index matching layer 102 may be selected according to the materials in the conductive layer 105, the second substrate 1013, and the first refractive index matching layer 103. For example, in the embodiments where the first refractive index matching layer 103 includes silicon oxide (SiOx), silicon nitride (SiNx), silicon oxynitride (SiOxNy), magnesium fluoride (MgF₂), or a combination thereof, the second refractive index matching layer 102 may include materials selected from the following list: silicon oxide (SiOx), silicon nitride (SiNx), silicon oxynitride (SiOxNy), titanium oxide (TiOx), niobium oxide (NbₓO_{y}), and indium tin oxide (ITO). This is done to ensure that the refractive index of the second refractive index matching layer 102 is between the refractive index of the conductive layer 105 and the refractive index of the second substrate 1013, and that it is larger than or equal to the refractive index of the first refractive index matching layer 103. The materials of the first refractive index matching layer 103 and the second refractive index matching layer 102 in the present disclosure are not limited to the materials mentioned above.

In the embodiments where the electronic device include both the first refractive index matching layer 103 and the second refractive index matching layer 102, the first refractive index matching layer 103 and the second refractive index matching layer 102 may have thickness between 50 Å and 2000 Å(50 Å≤thickness≤2000 Å) respectively. For example, the thickness of the first refractive index matching layer 103 may be between 50 and 1800 Å(50 Å≤thickness 1800 Å), between 100 Å and 1500 Å(100 Å≤thickness≤1500 Å), or between 100 Å and 1100 Å(100 Å≤thickness≤1100 Å). The thickness of the second refractive index matching layer 102 may be between 50 Å and 1800 Å(50 Å≤thickness≤1800 Å), between 100 Å and 1600 Å(100 Å thickness≤1600 Å), or between 100 Å and 1500 Å(100 Å≤thickness≤1500 Å).

Compared to the prior art, the electronic device comprising one or more refractive index matching layers as described in the present disclosure may have a lower reflectivity.

Please refer to FIGS. 5 to 11. Some specific examples of the present disclosure are provided below for further illustrating the advantages of the present disclosure over the prior art, but the advantages of the present disclosure are not limited thereto.

### Comparative Example 1

An electronic device 10 includes a display panel 101 including a display area DA, a non-display area NDA surrounding the display area DA, and a bonding area BA. The display panel 101 includes a first substrate 1011 and a second substrate 1013. A conductive layer 105 is formed above the second substrate 1013 of the display panel 101 by physical vapor deposition or the like. The conductive layer 105 may include, but is not limited to, indium tin oxide, and it may be between 50 Å and 230 Å(50 Å≤thickness≤230 Å) thick. The conductive layer 105 can cover the entire display area of the panel, and the conductive pattern 107 may be located in the bonding area BA, where it electrically connects the conductive layer 105 to the display panel 101.

### Example 1

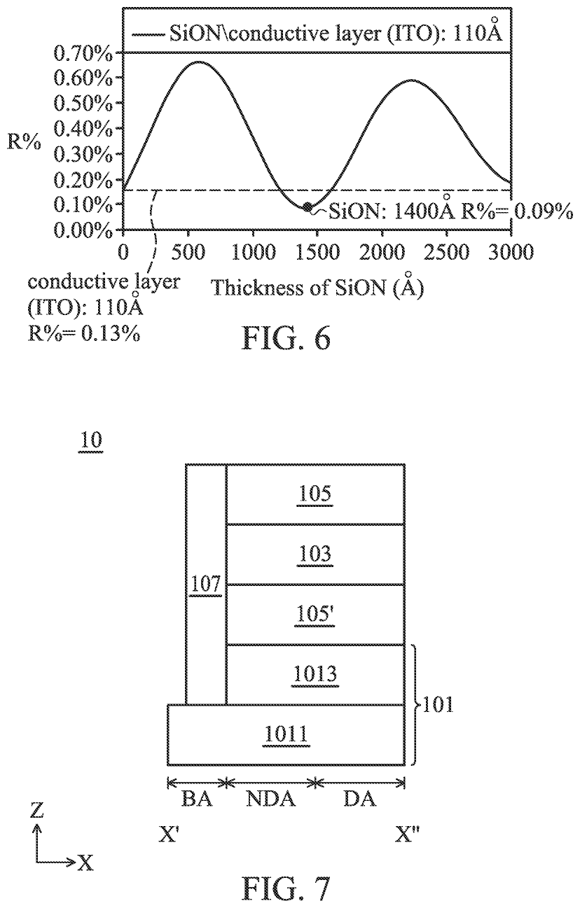

Please refer to FIG. 5 and FIG. 6. As shown in FIG. 5, the electronic device has the same display panel 101 and conductive layer 105 as that in Comparative Example 1, and a first refractive index matching layer 103 between the second substrate 1013 of the display panel 101 and the conductive layer 105. The first refractive index matching layer 103 has a given thickness and includes silicon oxynitride. The reflectivity variation of Example 1 (an electronic device has a structure shown in FIG. 5) shown in FIG. 6 is a simulation diagram obtained by using, for example, a thin film interference calculation method. As can be seen from FIG. 6, the reflectivity will vary with the thickness of the first refractive index matching layer 103. When the thickness of the first refractive index matching layer 103 is between 1300 Å and 1700 Å(1300 Å≤thickness 1700 Å), the reflectivity will be lower. It should be noted that Example 1 is only an example, and when the material of the first refractive index matching layer 103 changes, the value of the minimum reflectivity and the thickness to reach the minimum reflectivity may also be different from this Example.

### Example 2

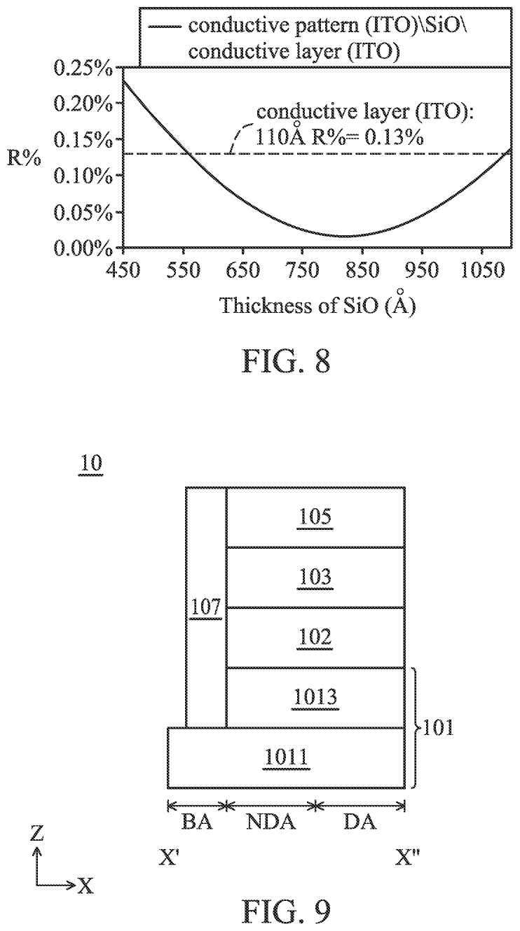

Please refer to FIG. 7 and FIG. 8. As shown in FIG. 7, the electronic device has the same display panel 101 and conductive layer 105 as that in Comparative Example 1, another conductive layer 105′ and a first refractive index matching layer 103 between the second substrate 1013 of the display panel 101 and the conductive layer 105. The thickness of the conductive layer 105′ is between 50 Å and 230 Å(50 Å≤thickness≤230 Å). The material in conductive layer 105′ may be the same as that in conductive layer 105, and the details are not repeated herein. The first refractive index matching layer 103 has a thickness and includes silicon oxide. The first refractive index matching layer 103 is between the conductive layer 105 and the conductive layer 105′. The reflectivity variation of Example 2, in which the thickness of the conductive layer 105′ is 110 Å as shown in FIG. 8, is a simulation diagram obtained by using, for example, a thin film interference calculation method. As can be seen from FIG. 8, the reflectivity will vary with the thickness of the first refractive index matching layer 103. When the thickness of the first refractive index matching layer 103 is between 550 Å and 1100 Å(550 Å≤thickness≤1100 Å), the reflectivity will be lower. For example, when the thickness of the first refractive index matching layer 103 is 850 Å, the reflectivity is close to the lowest value. It should be noted that Example 2 is only an example. In cases where the thickness of the conductive layer is fixed, the value of the minimum reflectivity and the thickness of the first refractive index matching layer 103 to achieve the minimum reflectivity may be changed with the material of the first refractive index matching layer 103. Therefore, the value of the minimum reflectivity and the thickness to achieve the minimum reflectivity may be different from this Example.

### Example 3

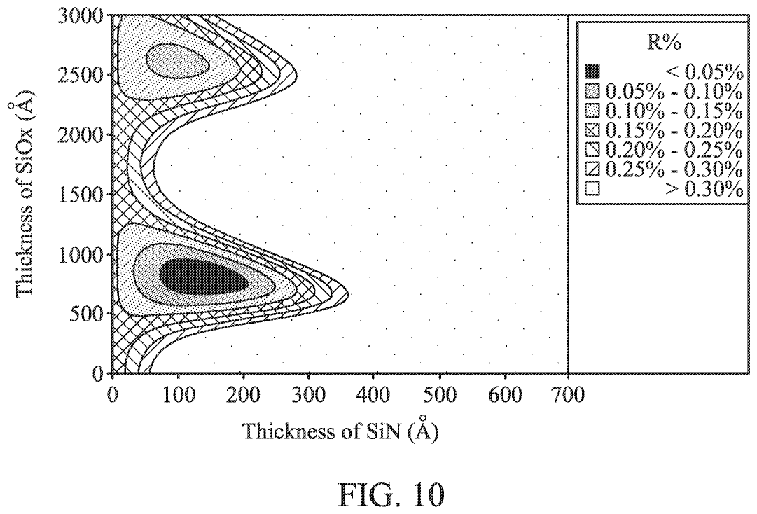

Please refer to FIG. 9 and FIG. 10. As shown in FIG. 9, the electronic device has the same display panel 101 and conductive layer 105 as that in Comparative Example 1, a first refractive index matching layer 103 between the second substrate 1013 of the display panel 101 and the conductive layer 105, and a second refractive index matching layer 102 between the second substrate 1013 of the display panel 101 and the first refractive index matching layer 103. The first refractive index matching layer 103 has a first thickness and includes silicon oxide. The second refractive index matching layer 102 has a second thickness and includes silicon nitride. The reflectivity variation of Example 3 shown in FIG. 10 is a simulation diagram obtained by using, for example, a thin film interference calculation method. As can be seen from FIG. 10, the reflectivity will vary with the thickness of the first refractive index matching layer 103 (the vertical axis) and the thickness of the second refractive index matching layer 102 (the horizontal axis). For example, when the thickness of the first refractive index matching layer 103 is between 700 Å and 1000 Å(700≤thickness≤1000 Å) and the thickness of the second refractive index matching layer 102 is between 100 Å and 200 Å(100≤thickness≤200 Å), the reflectivity is close to the lowest value. It should be noted that Example 3 is only an example. The value of the minimum reflectivity and the thickness of the first refractive index matching layer 103 and the second refractive index matching layer 102 to achieve the minimum reflectivity may be changed with the material of the first refractive index matching layer 103 and the second refractive index matching layer 102. Therefore, the value of the minimum reflectivity and the thickness to achieve the minimum reflectivity may be different from this Example, such as Example 4.

### Example 4

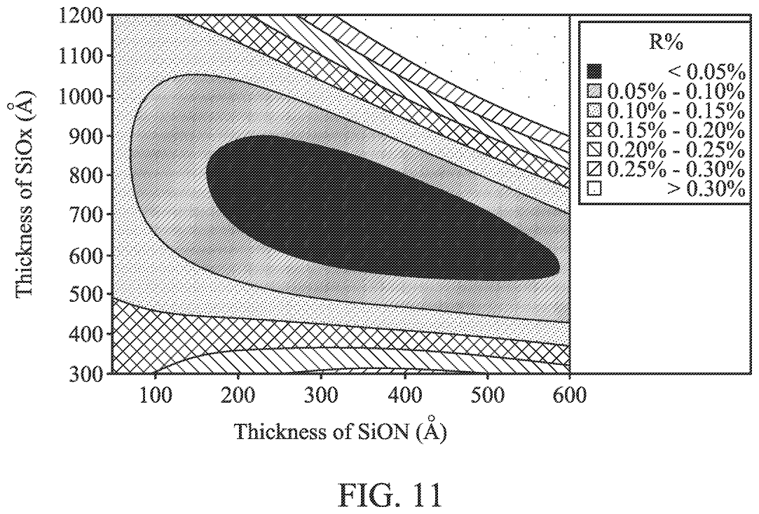

Please refer to FIG. 9 and FIG. 11. A mentioned above, The value of the minimum reflectivity and the thickness of the first refractive index matching layer 103 and the second refractive index matching layer 102 to achieve the minimum reflectivity may be changed with the material of the first refractive index matching layer 103 and the second refractive index matching layer 102. In Example 4, the electronic device has the same display panel 101 and conductive layer 105 as that in Comparative Example 1, a first refractive index matching layer 103 between the second substrate 1013 of the display panel 101 and the conductive layer 105, and a second refractive index matching layer 102 between the second substrate 1013 of the display panel 101 and the first refractive index matching layer 103. The first refractive index matching layer 103 has a third thickness and includes silicon oxide. The second refractive index matching layer 102 has a fourth thickness and including silicon oxynitride. The reflectivity variation of Example 4 may be shown in FIG. 11. When the thickness of the first refractive index matching layer 103 is between 600 Å and 900 Å(600≤thickness≤900 Å) and the thickness of the second refractive index matching layer 102 is between 200 Å and 600 Å(200≤thickness≤600 Å), the reflectivity is close to the lowest value.

Table 1 shows based on the structure of the Comparative Example, Example 1 to Example 4 above, the thickness of the refractive index matching layers in the Comparative Example, Example 1 to Example 4 when the reflectivity of the Comparative Example, Example 1 to Example 4 is close to the minimum value.

TABLE 1

| | Comparative | Example | Example | Example | Example |
|---|---|---|---|---|---|
| | Example 1 | 1 | 2 | 3 | 4 |
| Conductive | 110 Å | 110 Å | 110 Å | 110 Å | 110 Å |
| Layer(ITO) | | | | | |
| Silicon Oxynitride | — | 1400 Å | | | 400 Å |
| (SiOxNy) | | | | | |
| Silicon Oxide | | | 850 Å | 800 Å | 700 Å |
| (SiOx) | | | | | |
| Silicon Nitride | | | | 150 Å | |
| (SiNx) | | | | | |
| Conductive Layer | — | — | 110 Å | — | — |
| (ITO) | | | | | |
| Reflectivity (R %) | 0.16% | 0.09% | 0.04% | 0.02% | 0.04% |

As can be seen from the results in Table 1 above, compared to Comparative Example 1, the electronic device including a refractive index matching layer has a lower reflectivity, which can resolve the problem of lowering contrast of the display panel when the display panel is illuminated by an external light source resulted from the high reflectivity of the display panel.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An electronic device, comprising:
a display panel, comprising:
a first substrate; and
a second substrate above the first substrate;
a conductive layer above the second substrate; and
a first refractive index matching layer between the conductive layer and the second substrate,
wherein a refractive index of the first refractive index matching layer is smaller than a refractive index of the conductive layer.

2. The electronic device as claimed in claim 1, wherein the refractive index of the first refractive index matching layer is between the refractive index of the conductive layer and a refractive index of the second substrate.

3. The electronic device as claimed in claim 1, wherein the display panel comprises a display area and a non-display area surrounding the display area, and the conductive layer covers the entire display area.

4. The electronic device as claimed in claim 1, wherein the display panel comprises a display area and a non-display area surrounding the display area, and the conductive layer covers the entire display area and a portion or entire of the non-display area.

5. The electronic device as claimed in claim 1, wherein the display panel comprises a display area and a non-display area surrounding the display area, and the first refractive index matching layer covers the entire display area.

6. The electronic device as claimed in claim 1, wherein the display panel comprises a display area and a non-display area surrounding the display area, and the first refractive index matching layer covers the entire display area and a portion or entire of the non-display area.

7. The electronic device as claimed in claim 1, further comprising a second refractive index matching layer between the first refractive index matching layer and the second substrate, wherein a refractive index of the second refractive index matching layer is larger than or equal to the refractive index of the first refractive index matching layer.

8. The electronic device as claimed in claim 7, wherein the refractive index of the second refractive index matching layer is between the refractive index of the conductive layer and a refractive index of the second substrate.

9. The electronic device as claimed in claim 7, wherein the display panel comprises a display area and a non-display area surrounding the display area, and the second refractive index matching layer covers the entire display area.

10. The electronic device as claimed in claim 7, wherein the display panel comprises a display area and a non-display area surrounding the display area, and the second refractive index matching layer covers the entire display area and a portion or entire of the non-display area.

11. The electronic device as claimed in claim 7, wherein a thickness of the second refractive index matching layer is between 50 Å and 2000 Å.

12. The electronic device as claimed in claim 7, wherein the first refractive index matching layer comprises a material selected from a group consisting of silicon oxides (SiOx), silicon nitrides (SiNx), silicon oxynitrides (SiOxNy), magnesium fluorides (MgF₂), and a combination thereof.

13. The electronic device as claimed in claim 7, wherein the second refractive index matching layer comprises a material selected from a group consisting of silicon oxides (SiOx), silicon nitrides (SiNx), silicon oxynitrides (SiOxNy), titanium oxides (TiOx), niobium oxides (NbₓO_{y}), indium tin oxides (ITO) and a combination thereof.

14. The electronic device as claimed in claim 1, further comprising a conductive pattern electrically connecting the conductive layer and the display panel.

15. The electronic device as claimed in claim 1, wherein a thickness of the conductive layer is between 50 Å and 230 Å.

16. The electronic device as claimed in claim 1, wherein the conductive layer comprises a transparent conductive material.

17. The electronic device as claimed in claim 1, further comprising another conductive layer between the second substrate and the conductive layer.

18. The electronic device as claimed in claim 17, wherein a thickness of the another conductive layer is between 50 Å and 230 Å.

19. The electronic device as claimed in claim 17, wherein the first refractive index matching layer is between the conductive layer and the another conductive layer.

20. The electronic device as claimed in claim 1, wherein a thickness of the first refractive index matching layer is between 50 Å and 2000 Å.
